(19) United States
(12) Patent Application Publication
(10) Pub. No.: US 2007/0229450 A1
(43) Pub. Date: Oct. 4, 2007

(54) Driving apparatus and method for driving light emitting elements, and projector

(75) Inventor: Hideo Suzuki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 11/729,163

(22) Filed: Mar. 28, 2007

(30) Foreign Application Priority Data
Mar. 31, 2006 (JP) 2006-096915

(51) Int. Cl. G09G 3/36

(52) U.S. Cl. 345/102

(57) ABSTRACT

A light-emitting element driving apparatus, method and projector are provided, in which a common power supplying section drives plural light emitting elements of different rated current values in a time division driving manner to make them emit light stably.

The light-emitting element driving apparatus comprises a direct-current power source 13 for supplying direct current I-in, a light-emitting element selection controlling section 11 for selecting light emitting elements 10R, 10G, 10B, successively, to which elements different rated current values are set respectively, a power supplying section 13 for changing the direct current supplied from the direct-current power source 13 to a predetermined output current value and supplying output current I-out of the predetermined output current value to the light emitting element selected by the light-emitting element selection controlling section 11, an output current consuming section 14 for consuming the output current I-out supplied from the power supplying section 13, and a current consumption controlling section 15 for supplying the output current I-out of the power supplying section 13 to the output current consuming section 14 only for a predetermined adjustment period, when the light-emitting element selection controlling section selects a predetermined one among the light emitting elements.

### BACKGROUND OF THE INVENTION

The present invention relates to a light-emitting element driving apparatus and method for driving plural light-emitting elements in a time division driving manner, and a projector using such apparatus and method.

In conventional projectors, for example, a field sequential color system and color image synthesis system are used to project color images.

In the field sequential color system, a red image (R image), green image (G image), and blue image (B image) are projected onto a screen sequentially and periodically at a so high switching speed that human can recognize one color image. A projector of a field sequential color system is in practical use, in which DMD (Digital Micro-mirror Device) is used as an optical modulating device for transmitting image information output from a personal computer by means of optical beam. In the projector, light from a light source is collected onto DMD through a color wheel (color filter) having red, green and blue areas arranged in its rotational direction, and light reflected on the color wheel is projected onto a screen. While the color Wheel rotates, DMD is mechanically driven in synchronization with the rotating color wheel so as to correspond to a red image, green image and blue image, and further a red, green, and blue color image component reflected on DMD are projected onto the screen, whereby a color image is composed on the screen.

In recent, a projector of another type has been developed, which uses a red light emitting element (LED), green light emitting element (LED), and blue light emitting element (LED) as a light source, and these LEDs are driven successively in a time division driving manner, whereby a color image is projected onto the screen without using the color wheel (Refer to Patent Document: Japanese Patent No. 2004-311635 A).

### SUMMARY OF THE INVENTION

According to one aspect of the invention, there is provided a light-emitting element driving apparatus, which comprises a direct-current power source for supplying direct current, a light-emitting element selection controlling section for selecting light emitting elements successively, to which elements different rated current values are set respectively, a power supplying section for changing the direct current supplied from the direct-current power source to a predetermined output current value and supplying output current of the predetermined output current value to the light emitting element selected by the light-emitting element selection controlling section, an output current consuming section for consuming the output current supplied from the power supplying section, and a current consumption controlling section for supplying the output current of the power supplying section to the output current consuming section only for a predetermined adjustment period, when the light-emitting element selection controlling section selects a predetermined one among the light emitting elements.

According to another aspect of the invention, there is provided a method for driving light emitting elements, which comprises the steps of (a) selecting light emitting elements successively, to which elements different rated current values are set respectively, (b) changing direct current supplied from a direct-current power source to a predetermined output current value and supplying output current of the predetermined output current value to the selected light emitting element, and (c) supplying the output current to an output current consuming section only for a predetermined adjustment period, when a predetermined light emitting element is selected.

### BRIEF DESCRIPTION OF THE DRAWINGS

FIG. 1 is a block diagram of a light-emitting element driving apparatus of the present invention for driving light emitting elements.

FIG. 2 is a view explaining a time division driving operation for driving the light emitting elements.

FIG. 3 is a timing chart for explaining a switching operation of switching elements.

FIG. 4A is a view explaining relationship between resistance and adjustment time.

FIG. 4B is a view explaining a timing at which output current is supplied to an output current consuming section.

FIG. 5 is a view explaining an example of improvement in a response speed.

FIG. 6 is a view explaining a timing at which output current is supplied to an output current consuming section in another embodiment.

### DETAILED DESCRIPTION OF THE PREFERRED EMBODIMENTS

Now, an embodiment of a light-emitting element driving apparatus for driving LEDs (light emitting diodes) according to the present invention will be described with reference to the accompanying drawings. The light-emitting element driving apparatus (hereinafter, “driving apparatus”) is provided with three LEDs 10R, 10G and 10B, which are driven in a time sharing manner to emit red light (R light), green light (G light) and blue light (B light), respectively. Note that the number of LEDs is not limited to three and light to be emitted is not limited to red, blue and green light in the present invention.

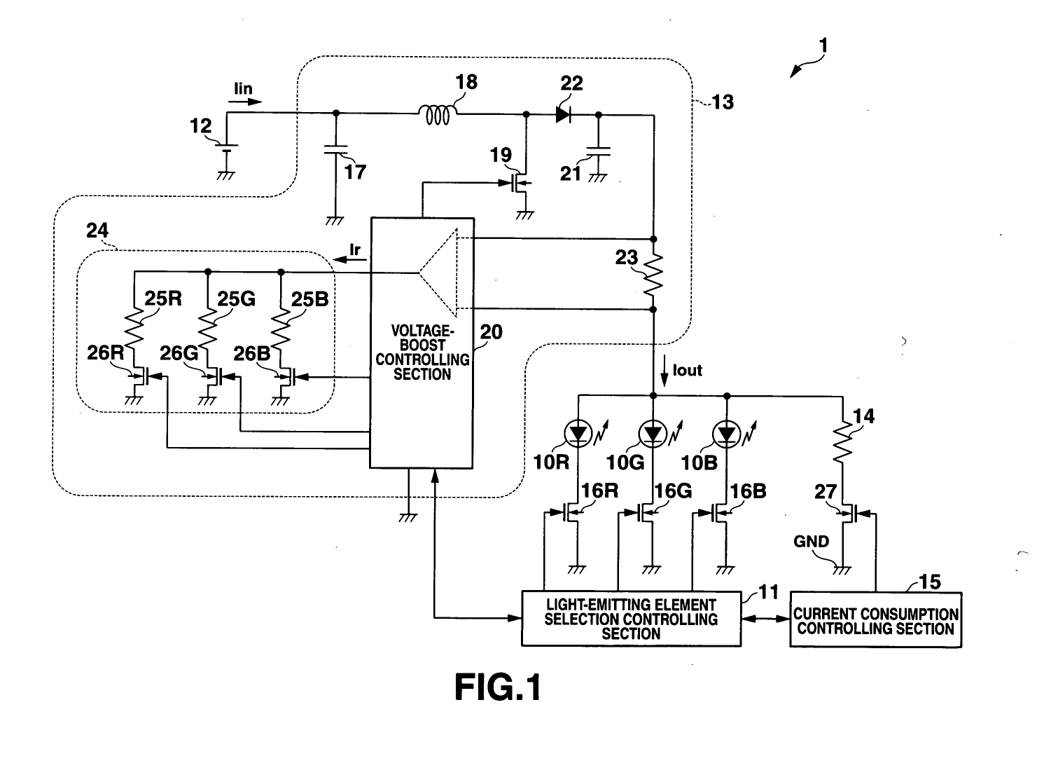

The driving apparatus 1 of the invention is installed for example in a projector, which is used to enlarge and project onto a large screen an explanation image created with a personal computer. A functional block diagram of the driving apparatus 1 is shown in FIG. 1. As shown in FIG. 1, the driving apparatus 1 comprises a light-emitting element selection controlling section 11, power supplying section 13, output-current consuming section 14, and current consumption controlling section 15. The light-emitting element selection controlling section 11 serves to select LEDs 10R, 10G, 10G successively. The power supplying section 13 serves to adjust input current I-in supplied from DC power source 12 to supply output current of a current value I-out to the light emitting element selected by the light-emitting element selection controlling section 11. The output-current consuming section 14 serves to consume the output current I-out supplied from the power supplying section 13. The current consumption controlling section 15 allows the output current I-out to flow from the power supplying section 13 to the output-current consuming section 14 only for a predetermined adjustment-period, when a predetermined light-emitting element is selected by the light-emitting element selection controlling section 11.

The light-emitting element selection controlling section 11 turns on or off switching elements 16R, 16G and 16B corresponding respectively to LEDs 10R, 10G and 10B successively, thereby selecting one LED which is to be supplied with the output current I-out from the power supplying section 13.

The light-emitting element selection controlling section 11 adjusts timing of on-off operation of the switching elements 16R, 16G and 16B to prevent plural LEDs of different colors from being turned on simultaneously, due to delay in operation of the switching elements 16R, 16G and 16B.

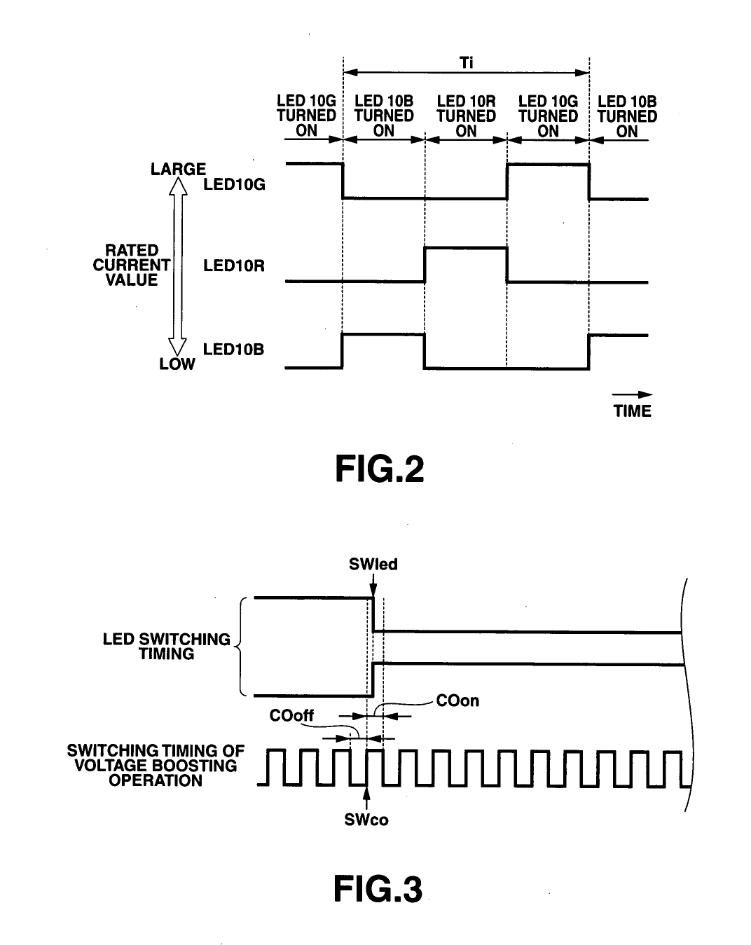

In the case that a rated current value is determined for each of LEDs 10R, 10G and 10B for emitting a light amount enough to give target luminance, and the rated current values for LED 10R for emitting red light, LED 10G for emitting green light and LED 10B for emitting blue light are set in the increasing order, the light-emitting element selection controlling section 11 controls on-off operation of the switching elements 16R, 16G and 16B, such that current is supplied from the current source section 13 to LEDs in the order of 10B, 10R and 10G successively within a predetermined period Ti, as shown in FIG. 2.

More specifically, the light-emitting element selection controlling section 11 controls on-off operation of the switching elements 16R, 16G and 16B, such that opportunities are decreased, at which LED of a large rated current value is switched to LED of a rated current that is lower than the large rated current, and further that LEDs 10R, 10G and 10B are driven in a time division driving manner within a predetermined period of Ti, for example, 2.8 ms.

The power supplying section 13 comprises an input smoothing condenser 17 for smoothing a voltage of the direct current source 12, boost coil 18 for boosting a voltage, switching element 19, voltage-boost controlling section 20 for controlling on-off operation of the switching element 19, output smoothing condenser 21 for smoothing an output voltage, rectifying diode 22, detection register 23 for detecting a current value, and a variable setting section 24 for adjusting a current value of output current.

In the power supplying section 13, when the switching element 19 is turned on under control of the voltage-boost controlling section 20, current is supplied from the direct current source 12 to the boost coil 18. As time lapses, energy proportional to square of current value flowing through the boost coil 18 is reserved in the boost coil 18.

When the voltage-boost controlling section 20 turns off the switching element 19 in the above state, the energy reserved in the boost coil 18 charges the output smoothing condenser 21 through the diode 22 and is also supplied through the register 23 to one element which is selected at the time out of LEDs 10R, 10G, 10B and the output-current consuming section 14.

The rectifying diode 22 serves to prevent charge reserved in the output condenser 21 from being discharged through the switching element 19, when the switching element 19 is turned on.

Then, when the switching element 19 is turned on, charging energy in the boost coil 18 starts and at the same time the charge which has been reserved in the condenser 21 when the switching element 19 is turned off last time is discharged and supplied through the register 23 to one element which is selected at the time out of LEDs 10R, 10G, 10B and the output-current consuming section 14.

The above operation is repeated, whereby energy is continuously supplied to load and also current I-out flows continuously.

The voltage-boost controlling section 20 detects a voltage drop appearing across the register 23, thereby controlling on-off operation of the switching element 19 so as to keep a value of the output current I-out supplied to LEDs 10R, 10G and 10B at a predetermined current value.

Though depending on the energy necessary for the load, a cycle of the on-off operation of the switching element 19 is in the order of not more than several tens μS, and the switching element 19 is driven at a cycle short enough in comparison with the time division driving period Ti of LED.

However, the voltage-boost controlling section 20 can generate a high voltage, thereby giving damage to the peripheral circuit, when a state of light load is temporarily caused due to switching operation, since the energy reserved in the boost coil 18 is discharged to the output side while the switching element 19 is kept off. Therefore, it is preferable that the light-emitting element selection controlling section 11 fine adjusts a timing SW-led at which LEDs are switched to be connected to the power supplying section 13 by means of the witching elements 16R, 16G and 16B so as to fall within a period CO-on in which the switching element 19 is kept turned on, as shown in FIG. 3. Further, it is preferable that the timing SW-led is fine adjusted such that the switching operation of LEDs will be completed within the period CO-on in which the switching element 19 is kept on.

The voltage-boost controlling section 20 controls the variable setting section 24 so as to supply the appropriate rated current values to LEDs 10R, 10G, 10B respectively.

The variable setting section 24 comprises registers 25R, 25G, 25B corresponding respectively to LEDs 10R, 10G, 10B, and switching elements 16R, 26G, 26B connected respectively to the registers 25R, 25G, 25B.

One end of the appropriate register among the registers 25R, 25G, 25B is connected to a reference potential (ground) through the appropriate switching element among the switching elements 16R, 26G, 26B at the switching timing of the appropriate LED, whereby current proportional to current Ir flowing through the register (grounded register) connected to the reference potential (ground) is supplied to LED corresponding to the grounded resister. The registers 25R, 25G, 25B are set to resistance values respectively such that the currents I-out to be supplied from the power supplying section 13 to LEDs 10R, 10G, 10B are set to the rated current values for LEDs 10R, 10G, 10G, respectively.

The voltage-boost controlling section 20 controls the on-off operation of the switching elements 26R, 26G, 26B in synchronization with selection of LEDs 10R, 10G, 10B, thereby grounding the register among the registers 25R, 25G, 25B corresponding to LED to which the power supplying section 13 supplies the current I-out.

In other words, when the power supplying section 13 supplies current to LED, the voltage-boost controlling section 20 connects the register corresponding to LED to which current is to be supplied to the reference potential (ground), thereby setting a predetermined current value corresponding to the rated current value for the LED to adjust the output current I-out of the power supplying section 13 to the above predetermined current, value.

When the light-emitting element selection controlling section 11 switches LED of a large rated current value to LED of a rated current value that is lower than the large rated current value, the current consumption controlling section 15 keeps the switching element 27 turned on for the predetermined adjustment-period to connect the output-current consuming section 14 to ground, thereby allowing the output current I-out of the power supplying section 13 to flow through the output-current consuming section 14 to ground.

More specifically, the power supplying section 13 sets the register in the variable setting section 24, thereby adjusting its output current I-out to the rated current value for each of LEDs 16R, 16G, 16B. And a current level of the boost coil 18 rises large enough to supply energy compensating the rated current value.

However, when the light-emitting element selection controlling section 11 switches LED of a large rated current value to LED of a low rated current value that is lower than the large rated current value, the current level of the boost coil 18 has risen to such extent that energy can excessively be supplied to LED of a low rated current value.

More specifically, when the light-emitting element selection controlling section 11 switches the green-light emitting LED 10G to the blue-light emitting LED 10B, the energy at the boost coil 18 has risen to the extent to supply current excessively to the blue-light emitting LED 10B at the LED switching operation by the light-emitting element selection controlling section 11.

The resister 14 grounded through the switching element 27 serves to discharge to ground rapidly excessive energy which is generated at the boost coil 18 at the time when the light-emitting element selection controlling section 11 switches the green-light emitting LED 10G to the blue-light emitting LED 10B. The register 14 has resistance which rapidly reduces the current level that has risen excessively when the LED switching operation is executed by the light-emitting element selection controlling section 11.

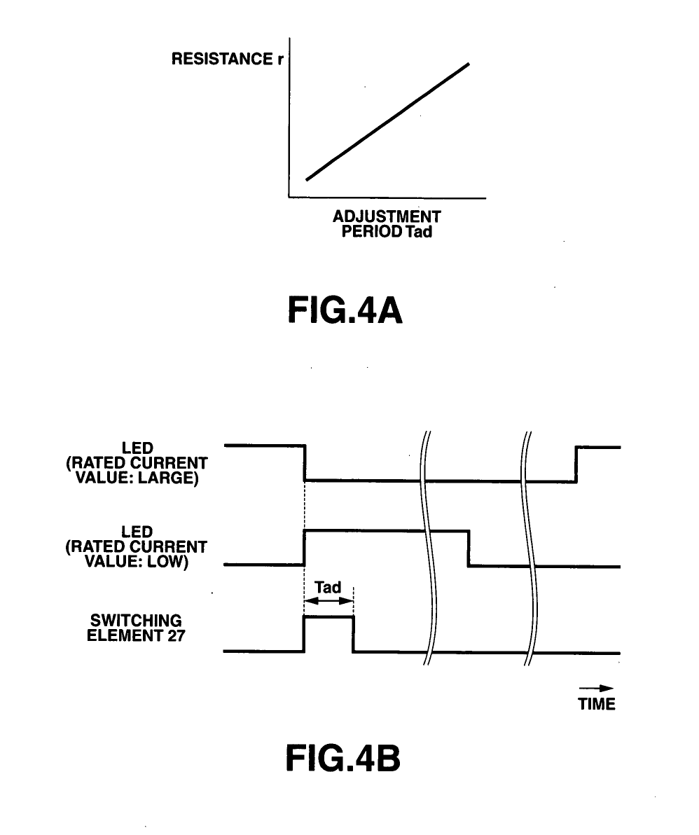

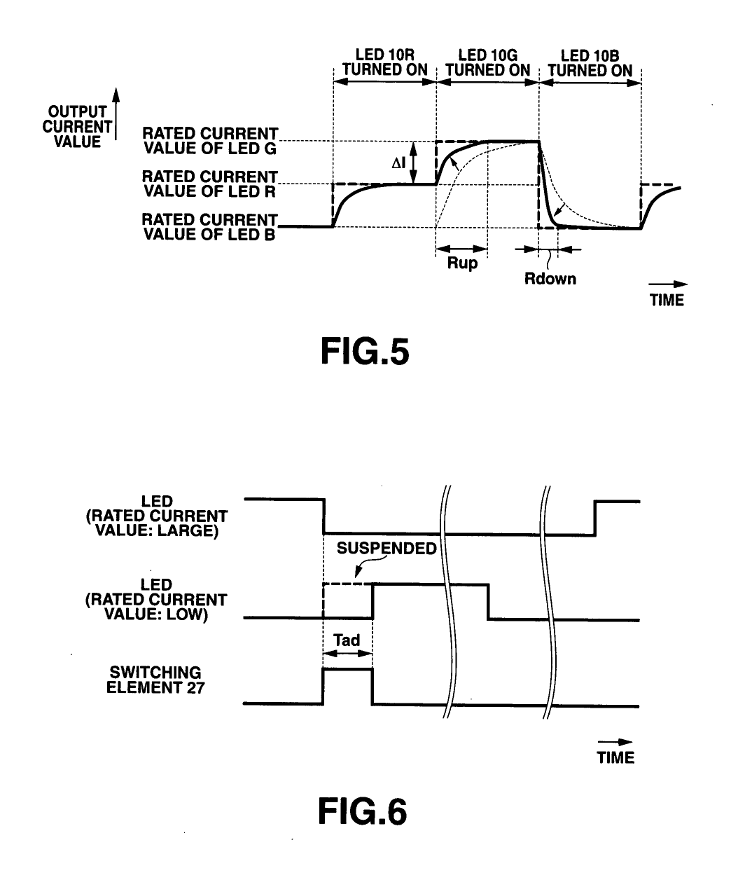

Meanwhile, the current consumption controlling section 15 stores an adjustment-period “Tad” corresponding to the resistance of the register 14 as shown in FIG. 4(a), in which period the register 14 prevents the excessively risen current level from being reduced excessively. Further, when the light-emitting element selection controlling section 11 switches LED of a large rated current value to LED of a low rated current value that is lower than the large rated current value, the current consumption controlling section 15 keeps the switching element 27 turned on during the adjustment-period “Tad” to allow the output current I-out to flow to ground through the register 14, as shown in FIG. 4(b).

In the light-emitting element driving apparatus 1 of the present invention, when the power supplying section 13 changes the rated current value to be supplied to LEDs 10R, 10G, 10B from a low current value to a large current value, LEDs are switched from LED of a low rated current value to LED of a large rated current value, whereby a time period “Rup” required by current to become stable around at the following rated current value is reduced by decreasing a difference ΔI between the rated current value supplied before LED is changed and the rated current value supplied after LED is changed to decrease change in the current level at the boost coil 18. When the power supplying section 13 changes the rated current value to be supplied to LEDs 10R, 10G, 10B from a large current value to a low current value, current is allowed to flow through the resister 14 to ground, whereby a time period “Rdown” required by current to become stable around at the following rated current value is reduced. In this way, light emitting elements of different rated current values can be driven to emit light more stably in a time division driving manner by a common power supplying section.

Now, another embodiment of the light-emitting element driving apparatus will be described. In the above embodiment of the light-emitting element driving apparatus, when the light-emitting element selection controlling section 11 switches LED of a large rated current value to LED of a low rated current value, the current consumption controlling section 15 keeps the switching element 27 turned on during the adjustment-period “Tad” to allow the output current I-out to flow through the register 14 to ground. But the light-emitting element selection controlling section 11 may be modified so as to suspend the switching operation of the switching element corresponding to the selected LED of a low rated current value, while the current consumption controlling section 15 keeps the switching element 27 turned on during the adjustment-period “Tad” to allow the output current I-out to flow through the register 14 to ground, as shown in FIG. 6. Further, current larger than the appropriate rated current value is prevented from flowing through LED of such rated current value, and therefore degradation of such LED of a low rated current value due to over current can be prevented.

The light emitting element driving apparatuses which are used for a projector have been described in the above embodiments, but the driving apparatus may be used for another devices such as a liquid crystal display device of a direct viewing type.

What is claimed is:

1. A light-emitting element driving apparatus, comprising:
a direct-current power source for supplying direct current;
a light-emitting element selection controlling section for selecting light emitting elements successively, to which elements different rated current values are set respectively;
a power supplying section for changing the direct current supplied from the direct-current power source to a predetermined output current value and supplying output current of the predetermined output current value to the light emitting element selected by the light-emitting element selection controlling section;
an output current consuming section for consuming the output current supplied from the power supplying section; and
a current consumption controlling section for supplying the output current of the power supplying section to the output current consuming section only for a predetermined adjustment period, when the light-emitting element selection controlling section selects a predetermined one among the light emitting elements.

2. The light-emitting element driving apparatus according to claim 1, wherein the current consumption controlling section supplies the output current of the power supplying section to the output current consuming section only for the predetermined adjustment period, when the light-emitting element selection controlling section switches a light emitting element of a high rated current value to a light emitting element of a rated current value which is lower than the high rated current value.

3. The light-emitting element driving apparatus according to claim 1, wherein the light-emitting element selection controlling section suspends supply of the output current from the power supplying section to the light emitting element selected by the light-emitting element selection controlling section while the power supplying section supplies the output current to the output current consuming section.

4. The light-emitting element driving apparatus according to claim 2, wherein the light-emitting element selection controlling section suspends supply of the output current from the power supplying section to the light emitting element selected by the light-emitting element selection controlling section while the power supplying section supplies the output current to the output current consuming section.

5. The light-emitting element driving apparatus according to claim 1, wherein the light-emitting element selection controlling section selects the light emitting elements successively such that opportunities are reduced at which the light emitting element of a high rated current value is switched to the light emitting element of a rated current value which is lower than the high rated current value.

6. The light-emitting element driving apparatus according to claim 2, wherein the light-emitting element selection controlling section selects the light emitting elements successively such that opportunities are reduced at which the light emitting element of a high rated current value is switched to the light emitting element of a rated current value which is lower than the high rated current value.

7. The light-emitting element driving apparatus according to claim 3, wherein the light-emitting element selection controlling section selects the light emitting elements successively such that opportunities are reduced at which the light emitting element of a high rated current value is switched to the light emitting element of a rated current value which is lower than the high rated current value.

8. The light-emitting element driving apparatus according to claim 4, wherein the light-emitting element selection controlling section selects the light emitting elements successively such that opportunities are reduced at which the light emitting element of a high rated current value is switched to the light emitting element of a rated current value which is lower than the high rated current value.

9. The light-emitting element driving apparatus according to claim 5, wherein the light-emitting element selection controlling section selects the light emitting elements successively in the ascending order in a rated current value of a light emitting element, and selects the light emitting element of the lowest rated current value after selection of the light emitting element of the highest rated current value.

10. The light-emitting element driving apparatus according to claim 6, wherein the light-emitting element selection controlling section selects the light emitting elements successively in the ascending order in rated current values of the light emitting elements, and selects the light emitting element of the lowest rated current value after selection of the light emitting element of the highest rated current value among the light emitting elements.

11. The light-emitting element driving apparatus according to claim 1, wherein the power supplying section changes the direct current supplied from the direct-current power source to a rated current value of the light emitting element selected by the light-emitting element selection controlling section.

12. The light-emitting element driving apparatus according to claim 2, wherein the power supplying section changes the direct current supplied from the direct-current power source to a rated current value of the light emitting element selected by the light-emitting element selection controlling section.

13. The light-emitting element driving apparatus according to claim 1, wherein the power supplying section has switching elements each performing switching operation to change the direct current supplied from the direct-current power source to a predetermined output current value, and the light-emitting element selection controlling section selects one of the light emitting elements in synchronization with the switching operation of the switching element.

14. The light-emitting element driving apparatus according to claim 2, wherein the power supplying section has switching elements each performing switching operation to change the direct current supplied from the direct-current power source to a predetermined output current value, and the light-emitting element selection controlling section selects one of the light emitting elements in synchronization with the switching operation of the switching element.

15. The light-emitting element driving apparatus according to claim 1, wherein the output current consuming section comprises a resister, one end of which is connected to a reference potential.

16. The light-emitting element driving apparatus according to claim 2, wherein the output current consuming section comprises a resister, one end of which is connected to the reference potential.

17. A method for driving light emitting elements, comprising the steps of:
(a) selecting light emitting elements successively, to which elements different rated current values are set respectively;
(b) changing direct current supplied from a direct-current power source to a predetermined output current value and supplying output current of the predetermined output current value to the selected light emitting element; and
(c) supplying the output current to an output current consuming section only for a predetermined adjustment period, when a predetermined light emitting element is selected.

18. A projector having a light-emitting element driving apparatus, the apparatus comprising:
a direct-current power source for supplying direct current;
a light-emitting element selection controlling section for selecting light emitting-elements successively, to which elements different rated current values are set respectively;
a power supplying section for changing the direct current supplied from the direct-current power source to a predetermined output current value and supplying output current of the predetermined output current value to the light emitting element selected by the light-emitting element selection controlling section;
an output current consuming section for consuming the output current supplied from the power supplying section; and
a current consumption controlling section for supplying the output current of the power supplying section to the output current consuming section only for a predetermined adjustment period, when the light-emitting element-selection controlling section selects a predetermined one among the light emitting elements.

19. The projector according to claim 18, wherein the current consumption controlling section supplies the output current of the power supplying section to the output current consuming section only for the predetermined adjustment period, when the light-emitting element selection controlling section switches a light emitting element of a high rated current value to a light emitting element of a rated current value which is lower than the high rated current value.

20. The projector according to claim 18, wherein the light-emitting element selection controlling section suspends supply of the output current from the power supplying section to the light emitting element selected by the light-emitting element selection controlling section while the power supplying section supplies the output current to the output current consuming section.
